(19) United States
(12) Patent Application Publication
(10) Pub. No.: US 2025/0377953 A1
(43) Pub. Date: Dec. 11, 2025

(54) RESOURCE ALLOCATION ADJUSTMENT BASED ON A PLURALITY OF PARAMETERS

(71) Applicant: Hewlett Packard Enterprise Development LP, Spring, TX (US)

(72) Inventor: Grace Priscilla Nambi, Bangalore (IN)

(21) Appl. No.: 18/802,292

(22) Filed: Aug. 13, 2024

(30) Foreign Application Priority Data
Jun. 10, 2024 (IN) 202441044877

(51) Int. Cl. G06F 9/50

(52) U.S. Cl. CPC G06F 9/5077; G06F 9/5072; G06F 2209/501; G06F 2209/5022

(57) ABSTRACT

In some examples, a system determines a program load of a program executing in a computing environment. The program load is determined based on a plurality of different usage parameters representing usage of different types of resources in the computing environment by the program, and based on respective resource allocation parameters representing allocations of the different types of resources. The system detects that the determined program load deviates from a load threshold for the program, and based on detecting that the determined program load deviates from the load threshold, adjusts a resource allocation parameter using an adjustment process that changes the resource allocation parameters in an order that depends upon whether the determined program load exceeds the load threshold or is less than the load threshold, wherein the adjusting of the resource allocation parameter modifies an allocation of a resource of the different types of resources to the program.

### BACKGROUND

A program executing in a computing environment makes use of various resources in the computing environment. The resources can include physical resources of the computing environment, virtual resources of the computing environment, or other types of resources.

### BRIEF DESCRIPTION OF THE DRAWINGS

Some implementations of the present disclosure are described with respect to the following figures.

FIG. 1 is a block diagram of an arrangement including a multi-dimensional auto-scalar system according to some examples.

FIG. 2 is a graphical view of a sphere representing a program load of a program, according to some examples.

FIG. 3 is a flow diagram of a process of adjusting a resource allocation for a program, according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Program performance may suffer if insufficient resources are allocated to a program during execution in a computing environment. For example, insufficient memory resource allocation to the program may result in a bottleneck occurring when the program attempts to use a memory. Similarly, insufficient processing resource allocation may lead to the program using a large percentage of the processing resource allocated to the program, which may mean that processes or tasks of the program may contend for usage of the processing resource.

In some examples, an auto-scalar system can automatically increase an allocation of specific resources for a program if the program's performance suffers due to resource bottlenecks encountered by the program. For example, the auto-scalar system may increase allocation of a processing resource or a memory resource to the program to add capacity to the program. However, the auto-scalar system in such examples does not consider an efficient order for performing scaling of resources. Increasing an allocation of certain resources may be more expensive than increasing an allocation of other resources. If the allocation of a more expensive resource is increased for the program, then costs associated with operating the program may increase. For example, a tenant of a cloud computing environment may be charged more for certain resources than other resources by a cloud computing provider. Also, increasing the allocation of a given type of resource for the program may mean that other concurrently running programs may not have access to the allocated given type of resource, which may lead to reduced performance of the other programs.

In accordance with some implementations of the present disclosure, a multi-dimensional auto-scalar system is able to apply automatic scaling of different types of resources for a program that seeks to balance performance and costs associated with allocations of the different types of resources. In some examples of the present disclosure, an order in which resource allocations of the different types of resources are adjusted is dependent upon whether a program load of the program exceeds or is less than a target load (a threshold load). For example, if the program load exceeds the target load, then the auto-scalar system according to some examples of the present disclosure adjusts allocations of the different types of resources to the program in a first order. However, if the program load is less than the target load, then the auto-scalar system adjusts allocations of the different types of resources to the program in a second order different from the first order. Changing the order of resource allocations of the different types of resources for different operating conditions of the program can achieve more efficient usage of resources by the program, which can improve both performance of the program and reduce costs associated with operating the program.

A “program load” of a program can refer to a capacity of the program to increase its performance if a performance of the program starts to suffer. The program load is inversely proportional to an allocation of resources to the program. In other words, the program load can be reduced by increasing an allocation of resources to the program, while the program load can be increased by reducing an allocation of resources to the program. Intuitively, by increasing an allocation of resources to the program, the program is able to make use of the increased allocation of resources when needed to improve the performance of the program. Equivalently, the program load of the program may also be referred to as a program capacity of the program.

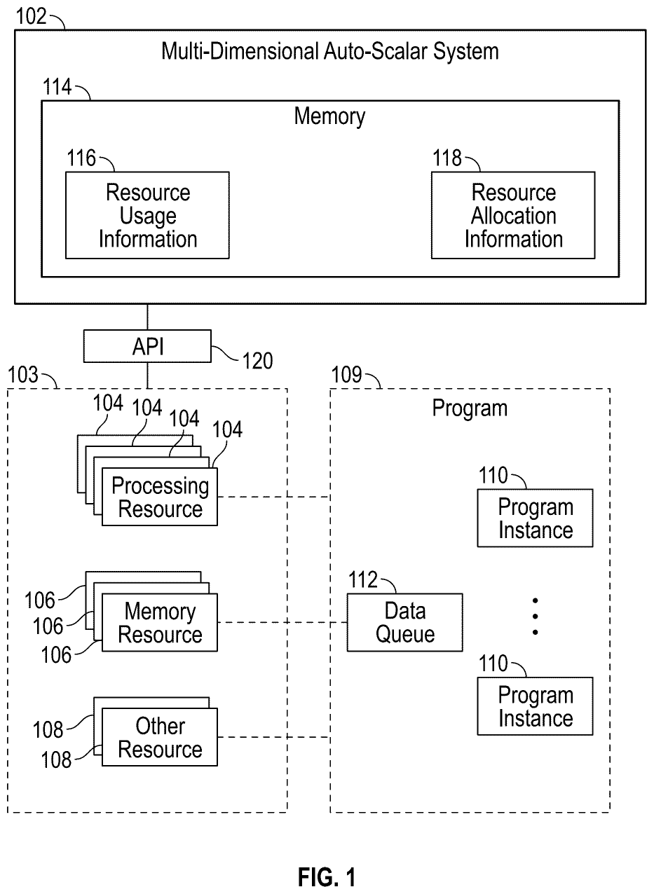

FIG. 1 is a block diagram of an example computing environment 100 that includes a multi-dimensional auto-scalar system 102 that is able to apply automatic scaling of different types of resources in the computing environment 100 for a program that executes in the computing environment. The auto-scalar system 102 is able to adjust allocations of the different types of resources to the program in different orders responsive to different operating conditions of the program, where an operating condition of the program is based on the program load of the program.

Examples of the computing environment 100 can include any or some combination of the following: a data center, a cloud computing environment, or any other type of computing environment in which programs can execute. A “program” can include machine-readable instructions, such as machine-readable instructions of software for firmware, for example.

The auto-scalar system 102 can be implemented using one or more computers. Although depicted as being part of the computing environment 100, in other examples, the auto-scalar system 102 can be separate from the computing environment 100. The computing environment 100 includes different types of resources 103, including processing resources 104, memory resources 106, and other resources 108. Examples of other resources 108 can include communication resources (e.g., network interface controllers, switches, routers, gateways, etc.), virtual resources (e.g., virtual machines or VMs, containers, etc.), program resources (e.g., services offered by machine-readable instructions), or further resources.

The different types of resources of the computing environment 100 can be allocated for use by different programs executing in the computing environment 100. FIG. 1 shows a program 109 executable in the computing environment 100. There may be additional programs executable in the computing environment 100 in further examples.

Multiple running instances of a given program may be invoked. An “instance” (or equivalently, a “program instance”) of the given program may refer to a thread of the given program or a process of the given program. The multiple instances of the given program may execute in parallel. The quantity of running instances of a program is considered a resource of the program that can be dynamically adjusted (i.e., the quantity of running instances of the program can be increased or decreased).

In the example of FIG. 1, program instances 110 of the program 109 are executed in the computing environment 100. Note that if there are multiple different types of programs executed in the computing environment 100, each type of program can be associated with a corresponding collection of instances of the type of program. Although multiple program instances 110 are shown in FIG. 1, in other examples, just a single instance 110 can be executed for the program 109.

The program 109 is associated with a data queue 112. The data queue 112 is used for buffering data for the program instances 110 of the program 109. Although just one data queue 112 is depicted in FIG. 1, note that there may be multiple data queues 112 for respective program instances 110. The size of the data queue 112 can be dynamically adjusted by the auto-scalar system 102.

In an example, if the program 109 is a communication program, the data queue 112 can be used to buffer messages communicated by the communication program. Other types of programs can also make use of data queues. The data queue 112 is a logical storage construct useable by the program 109 to store data. The data in the data queue 112 is physically stored in respective memory resources 106 accessible by the program 109. If the size of the data queue 112 is increased by the auto-scalar system 102, then a larger storage region of the memory resources 106 is allocated for the data queue 112. On the other hand, if the size of the data queue 112 is decreased by the auto-scalar system 102, then a smaller storage region of the memory resources 106 is allocated to the data queue 112. More generally, adjusting the size of the data queue 112 results in an adjustment of the amount of storage of the memory resources 106 allocated to the program 109.

Adjusting the allocation of processing resources 104 by the auto-scalar system 102 to the program 109 can include increasing or decreasing the quantity of processing resources 104 allocated to the program 109. The collection of program instances 110 of the program 109 can execute on the allocated quantity of processing resources 104. Allocations of the other resources 108 can also be dynamically adjusted by the auto-scalar system 10.

Further, as noted above, another resource that can be dynamically adjusted by the auto-scalar system 102 is an allocated quantity of program instances that can be invoked for the program 109. The allocated quantity of program instances can be the maximum quantity of program instances that can be invoked for the program 109.

The auto-scalar system 102 includes a memory 114 that can store resource usage information 116 and resource allocation information 118. The resource usage information 116 includes information representing the current usage of resources of the computing environment 100 by the program 109. The resource allocation information 118 includes information representing the allocation of resources to the program 109.

In some examples, the resource usage information 116 includes usage parameters that represent usage by the program 109 of different types of resources in the computing environment 100. The resource allocation information 118 can include resource allocation parameters that represent allocations of the different types of resources to the program 109.

Examples of usage parameters can be selected from any or some combination of the following: a usage parameter representing usage of the processing resources 104, a usage parameter representing usage of the memory resources 106 (e.g., a usage parameter representing a size of the data queue 112 that is currently being used), a usage parameter representing usage of communication resources, a usage parameter representing usage of virtual resources, a usage parameter representing usage of program resources, or a usage parameter representing a quantity of program instances 110 of the program 109 currently in use.

Examples of resource allocation parameters can be selected from any or some combination of the following: an allocation parameter representing an allocation of the processing resources 104, an allocation parameter representing an allocation of the memory resources 106 (e.g., an allocation parameter representing an allocated size of the data queue 112), an allocation parameter representing an allocation of communication resources, an allocation parameter representing an allocation of virtual resources, an allocation parameter representing an allocation of program resources, or an allocation parameter representing a quantity of program instances 110 of the program 109 that is allowed. Generally, an “allocation” of resources can refer to the maximum amount of the resources that is allowed to be used by the program 109.

The auto-scalar system 102 is able to determine a program load of the program 109 in the computing environment 100, based on usage parameters in the resource usage information 116. The usage parameters are in turn based on resource allocation parameters.

As discussed below, the auto-scalar system 102 applies automatic scaling of different types of resources in the computing environment 100 for the program 109 by adjusting the resource allocation parameters to change allocations of respective types of resources. Once a resource allocation parameter is adjusted, the auto-scalar system 102 can invoke an application programming interface (API) 120 to cause application of the adjusted resource allocation parameter. The API 120 may be associated with a resource management system (not shown) that is able to change allocations of resources according to resource allocation parameters. In other examples, instead of using the API 120, a different interface of the resource management system may be accessed by the auto-scalar system 102.

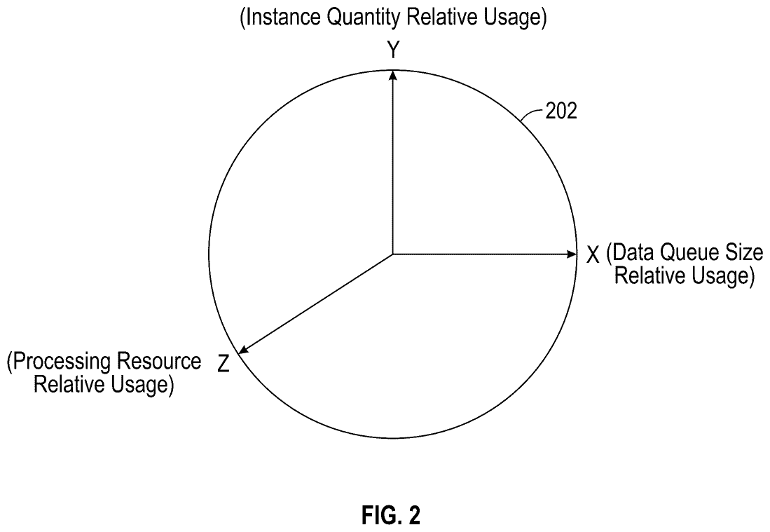

FIG. 2 is a graphical representation of a sphere 202 representing a program load of the program 109. The program load of the program 109 is based on three dimensions, including a lateral dimension represented by an X parameter, a horizontal dimension represented by a Y parameter, and a vertical dimension represented by a Z parameter. The X parameter represents the relative usage of the data queue 112 as currently used by the program 109. The relative usage of the data queue 112 is based on the currently used size of the data queue 112 divided by the allocated (maximum) size of the data queue 112.

The Y parameter represents the relative usage of the program instances 110 of the program 109. The relative usage of the program instances 110 is based on the currently invoked quantity of the program instances 110 divided by the allocated (maximum) quantity of program instances for the program 109.

The Z parameter represents the relative usage of the processing resources 104 by the program 109. The relative usage of the processing resources 104 is based on a current amount of processing resources 104 used by the program 109 divided by the allocated (maximum) amount of processing resources 104 that can be used by the program 109.

In some examples, the program load of the program 109 can be represented by the volume of the sphere 202. The radius (R) of the sphere 202 can be computed as follows:

$$R = \sqrt{{X}^{2} + {Y}^{2} + {Z}^{2}} . \qquad ( Eq . 1 )$$

The volume of the sphere 202 is. The program load (L) can be expressed as:

$$L = \frac{4}{3} π {R}^{3} . \qquad ( Eq . 2 )$$

The program 109 may be associated with a target program load, which is a program load of the program 109 that falls within a target range that includes the load threshold. For example, if the load threshold is L_{Th}, then the target program load can include a range [L_{lower}, Lᵤₚₚₑᵣ], where L_{Th} is within the range [L_{lower}, Lᵤₚₚₑᵣ].

In some examples, the target program load is represented by a target value of the radius R, which is set based on target values of the X parameter, the Y parameter, and the Z parameter. The target value each of X, Y, and Z can be predefined, such as by a human, machine-readable instructions, or a machine. For example, if the target value of X is 0.9, the target value of Y is 0.9, and the target value of Z is 0.9, then based on Eq. 1, the target (or optimal) value of R is 1.5588457268. This optimal value of R can be represented as Rₒₚₜ. In other examples, other target values of X, Y, and Z can be used.

In further examples, the program load of the program 109 may be computed based on more than three parameters. For example, in addition to or instead of the parameters representing the relative usage of the data queue 112, the relative usage of the program instances 110 of the program 109, and the relative usage of the processing resources 104, the program load of the program 109 can be based on additional parameters representing relative usage of other parameters. If more than four dimensions are used, then a graphical representation of the program load of the program 109 can be based on the volume of another type of graphical element.

In some examples, X can be computed as follows:

$$X = \frac{Current\_Q \_Size}{Allocated\_Q \_Size} \cdot Compute\_Resource \_In \_Use , \qquad ( Eq . 3 )$$

where Current_Q_Size represents a size of the data queue 112 as currently used by the program, Allocated_Q_Size represents the allocated data queue size, and C Compute_Resource_In_Use represents an amount of compute resources consumed by the program 109. As used here, the “compute resources” can refer to a collection of the resources (including any or some combination of 104, 106, and 108, for example) of the computing environment 100 that can be used by programs running in the computing environment 100. Compute_Resource_In_Use can represent a proportion of the compute resources used by the program 109 relative to compute resources used by all programs running in the computing environment 100.

In some examples, Y can be computed as follows:

$$Y = \frac{Current\_Instance \_Quantity}{Allocated\_Instance \_Quantity} \cdot Compute\_Resource \_In \_Use , \qquad ( Eq . 4 )$$

where Current_Instance_Quantity represents a currently invoked quantity of the program instances of the program 109, and Allocated_Instance_Quantity represents the allocated quantity of program instances that may be invoked.

In some examples, Z can be computed as follows:

$$Z = \frac{Current\_Used \_PR}{Allocated\_PR} \cdot Compute\_Resource \_In \_Use , \qquad ( Eq . 5 )$$

where Current_Used_PR represents the current amount of processing resources 104 used by the program 109, and Allocated_PR represents the allocated amount of processing resources 104 that can be used by the program 109.

Although Eqs. 3-5 use Compute_Resource_In_Use as part of the computation of X, Y, and Z, in other examples, Compute_Resource_In_Use can be omitted from Eqs. 3-5.

The program load is inversely proportional to each of Allocated_Q_Size, llocated_Instance_Quantity, and Allocated_PR. For example, if the auto-scalar system 102 increases the allocation of the data queue size, the program load is decreased. Similarly, if the auto-scalar system 102 increases the allocated quantity of program instances that may be invoked or increases the allocated amount of processing resources 104, the program load is decreased. Conversely, if the auto-scalar system 102 decreases the allocation of the data queue size, or decreases the allocated quantity of program instances that may be invoked, or decreases the allocated amount of processing resources 104, the program load is increased.

Increasing the size of the data queue 112 reduces contention for the queue space shared by the program instances 110. As a result, less processing overhead is associated with managing usage of the data queue 112, which reduces the program load. Increasing the allocated quantity of program instances can also reduce the program load, since more program instances 110 are available to perform the workload of the program 109. Further, increasing the allocated amount of processing resources 104 allows for more program instances 110 to be run concurrently or to avoid contention for the processing resources 104 by the program instances 110, which reduces the program load.

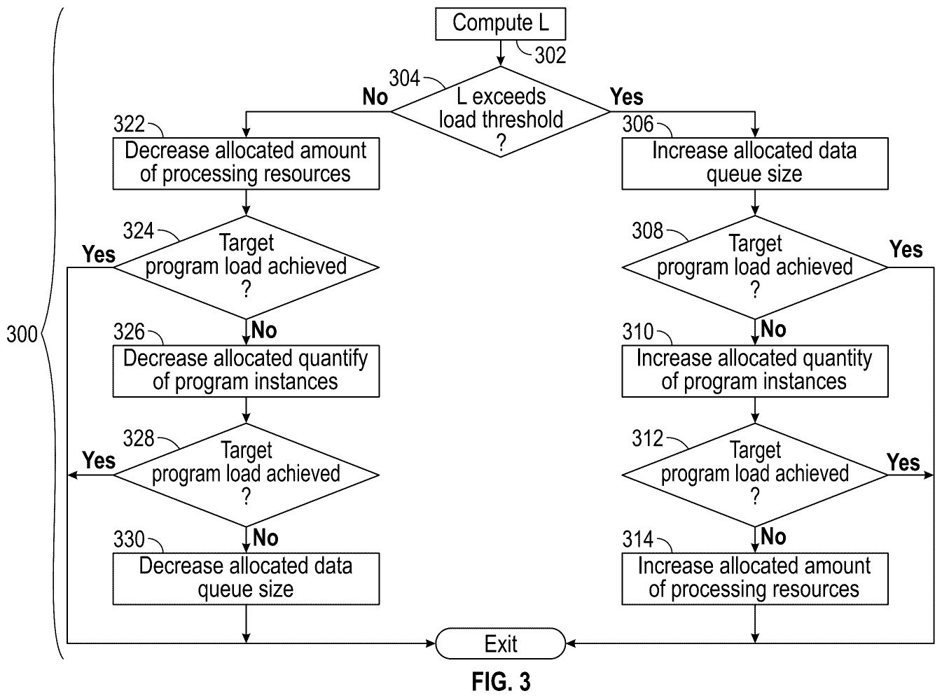

Scaling decisions performed by the auto-scalar system 102 is based on the program load (L) computed according to Eq. 2, for example, such as in a multi-dimensional auto-scaling process 300 depicted in FIG. 3. Although FIG. 3 shows a sequence of tasks, in other examples, the tasks can be performed in a different order, some tasks may be omitted, and additional tasks may be added.

The auto-scalar system 102 computes (at 302) the program load (L) according to Eq. 2, for example. The auto-scalar system 102 compares the computed program load to a load threshold for the program 109 to determine (at 304) whether the computed program load exceeds the load threshold. Note that the term “load threshold” can refer to a single load threshold or multiple load thresholds (e.g., an upper load threshold and a lower load threshold).

If the computed program load exceeds the load threshold for the program 109 (the “Yes” branch of the decision diamond 304), the auto-scalar system 102 adjusts the different resource allocation parameters (e.g., Allocated_Q_Size, Allocated_Instance_Quantity, and Allocated_PR) in a first order. In examples where multiple load thresholds are used, the “Yes” branch of the decision diamond 304 corresponds to the computed program load being greater than the upper load threshold.

However, if the computed program load does not exceed the load threshold for the program 109 (the “No” branch of the decision diamond 304), the auto-scalar system 102 adjusts the different resource allocation parameters (e.g., Allocated_PR, Allocated_Instance_Quantity, and Allocated_Q_Size) in a second order different from the first order. In examples where multiple load thresholds are used, the “No” branch of the decision diamond 304 corresponds to the computed program load being less than the lower load threshold.

The program 109 has several possible states, such as a hyper-state, an optimal state, and a hypo-state. The hyper-state of the program 109 is indicated when the computed program load exceeds the load threshold. The hypo-state of the program 109 is indicated when the computed program load is less than the load threshold. The optimal state of the program 109 is indicated when the computed program load falls within the target range (i.e., the program 109 has the target program load based on Rₒₚₜ as discussed further above).

In further examples, the program 109 may have more than three states indicated by the program load falling into respective different ranges. The auto-scalar system 102 can make different scaling decisions for the respective different states of the program 109. The different scaling decisions involve performing an adjustment process that changes the resource allocation parameters in different orders for the respective different states of the program 109.

By modifying the adjustment process for the different states of the program 109, the auto-scalar system 102 can increase the likelihood that the program 109 efficiently uses the resources of the computing environment 100 while achieving performance goals of the program 109. If multiple programs execute in the computing environment 100, the auto-scalar system 102 can ensure efficient sharing of the resources by the multiple programs.

If the auto-scalar system 102 determines (at 304) that the computed program load exceeds the load threshold, the auto-scalar system 102 can increase the value of Allocated_Q_Size to increase (at 306) the allocated data queue size.

For example, computing the increased value of Allocated_Q_Size can be based on Eq. 1, in which the auto-scalar system 102 finds the adjusted value of X while keeping Y and Z unchanged. More specifically, X_{adj} (the adjusted value of X) is derived according to Eq. 6 below.

$${X}_{adj} = \sqrt{{{R}_{opt}}^{2} - {Y}^{2} - {Z}^{2}} . \qquad ( Eq . 6 )$$

Given X_{adj}, Eq. 3 can be used to find the adjusted value of Allocated_Q_Size based on the Current_Q_Size that is being used. Note that Allocated_Q_Size may not be increased beyond a predefined maximum data queue size. As a result, it may be possible that increasing Allocated_Q_Size may not achieve the target program load.

The auto-scalar system 102 determines (at 308) whether increasing the allocated data queue size can achieve the target program load, e.g., the program load falls within the range [L_{lower}, Lᵤₚₚₑᵣ], where L_{Th} is within the range [L_{lower}, Lᵤₚₚₑᵣ]. Note that in examples where multiple load thresholds are used, L_{lower} can be the lower load threshold, and Lᵤₚₚₑᵣ can be the upper load threshold.

If increasing the allocated data queue size causes the program load (L) to fall within the range [L_{lower}, Lᵤₚₚₑᵣ], then the auto-scalar system 102 can make a determination that increasing the allocated data queue size can achieve the target program load, and the auto-scalar system 102 can exit the auto-scaling process 300 without increasing allocations of other types of resources.

However, if the auto-scalar system 102 determines (at 308) that increasing the allocated data queue size cannot achieve the target program load (e.g., L computed according to Eq. 2 does not fall in the range [L_{lower}, Lᵤₚₚₑᵣ]), the auto-scalar system 102 increases the value of Allocated_Instance_Quantity to increase (at 310) the allocated quantity of program instances.

For example, computing the increased value of Allocated_Instance_Quantity can be based on Eq. 1, in which the auto-scalar system 102 finds the adjusted value of Y while using X_{adj} and keeping Z unchanged. More specifically, Y_{adj} (the adjusted value of Y) is derived according to Eq. 7 below.

$${Y}_{adj} = \sqrt{{{R}_{opt}}^{2} - {{X}_{adj}}^{2} - {Z}^{2}} . \qquad ( Eq . 7 )$$

Given Y_{adj}, Eq. 4 can be used to find the adjusted value of Allocated_Instance_Quantity based on the Current_Instance_Quantity that is being used. Note that Allocated_Instance_Quantity may not be increased beyond a predefined maximum allocated quantity of program instances. As a result, it may be possible that increasing Allocated_Q_Size and increasing Allocated_Instance_Quantity (306 and 310, respectively) may not achieve the target program load.

The auto-scalar system 102 determines (at 312) whether increasing the allocated data queue size and increasing the allocated quantity of program instances can achieve the target program load. If so, the auto-scalar system 102 can exit the auto-scaling process 300 without increasing allocations of other types of resources.

If the auto-scalar system 102 determines (at 312) that increasing the allocated data queue size and increasing the allocated quantity of program instances cannot achieve the target program load, the auto-scalar system 102 increases the value of Allocated_PR to increase (at 314) the allocated amount of processing resources 104.

For example, computing the increased value of Allocated_PR can be based on Eq. 1, in which the auto-scalar system 102 finds the adjusted value of Z while using X_{adj} and Y_{adj}. More specifically, Z_{adj} (the adjusted value of Z) is derived according to Eq. 8 below.

$${Z}_{adj} = \sqrt{{{R}_{opt}}^{2} - {{X}_{adj}}^{2} - {{Y}_{adj}}^{2}} . \qquad ( Eq . 8 )$$

Given Z_{adj}, Eq. 5 can be used to find the adjusted value of Allocated_PR based on the Current_Used_PR that is being used. Note that Allocated_PR may not be increased beyond a predefined maximum allocated amount of processing resources.

The auto-scalar system 102 then exits the auto-scaling process 300.

If the auto-scalar system 102 determines (at 304) that the computed program load does not exceed the load threshold (the “No” branch from the decision diamond 304), the auto-scalar system 102 can decrease the value of Allocated_PR to decrease (at 322) the allocated amount of processing resources 104, such as by using Eq. 8 to find Z_{adj} and then using Eq. 5 to find the adjusted value of Allocated_PR. Note that Allocated_PR may not be decreased beyond a predefined minimum allocated amount of processing resources. As a result, it may be possible that decreasing Allocated_PR may not achieve the target program load.

The auto-scalar system 102 determines (at 324) whether decreasing the allocated amount of processing resources 104 can achieve the target program load. If so, the auto-scalar system 102 can exit the auto-scaling process 300 without adjusting other types of resources.

However, if the auto-scalar system 102 determines (at 324) that decreasing the allocated amount of processing resources 104 cannot achieve the target program load, the auto-scalar system 102 decreases the value of Allocated_Instance_Quantity to decrease (at 326) the allocated quantity of program instances, such as by using Eq. 7 to find Y_{adj} and then using Eq. 4 to find the adjusted value of Allocated_Instance_Quantity. Note that Allocated_Instance_Quantity may not be decreased beyond a predefined minimum allocated quantity of program instances. As a result, it may be possible that decreasing Allocated_PR and decreasing Allocated_Instance_Quantity (322 and 326, respectively) may not achieve the target program load.

The auto-scalar system 102 determines (at 328) whether decreasing the allocated amount of processing resources 104 and decreasing the allocated quantity of program instances can achieve the target program load. If so, the auto-scalar system 102 can exit the auto-scaling process 300 without decreasing allocations of other types of resources.

If the auto-scalar system 102 determines (at 328) that decreasing the allocated amount of processing resources 104 and decreasing the allocated quantity of program instances cannot achieve the target program load, the auto-scalar system 102 decreases the value of Allocated_Q_Size to decrease (at 330) the allocated data queue size, such as by using Eq. 6 to find X_{adj} and then using Eq. 3 to find the adjusted value of Allocated_Q_Size. Note that Allocated_Q_Size may not be decreased beyond a predefined minimum data queue size.

The auto-scalar system 102 then exits the auto-scaling process 300.

In the example of FIG. 3, If the computed program load exceeds the load threshold, the auto-scalar system 102 first adjusts Allocated_Q_Size, then adjusts Allocated_Instance_Quantity, and then adjusts Allocated_PR (the first order in some examples). However, if the computed program load does not exceed the load threshold, the auto-scalar system 102 first Allocated_PR, then adjusts Allocated_Instance_Quantity, and then adjusts Allocated_Q_Size) (the second order in some examples).

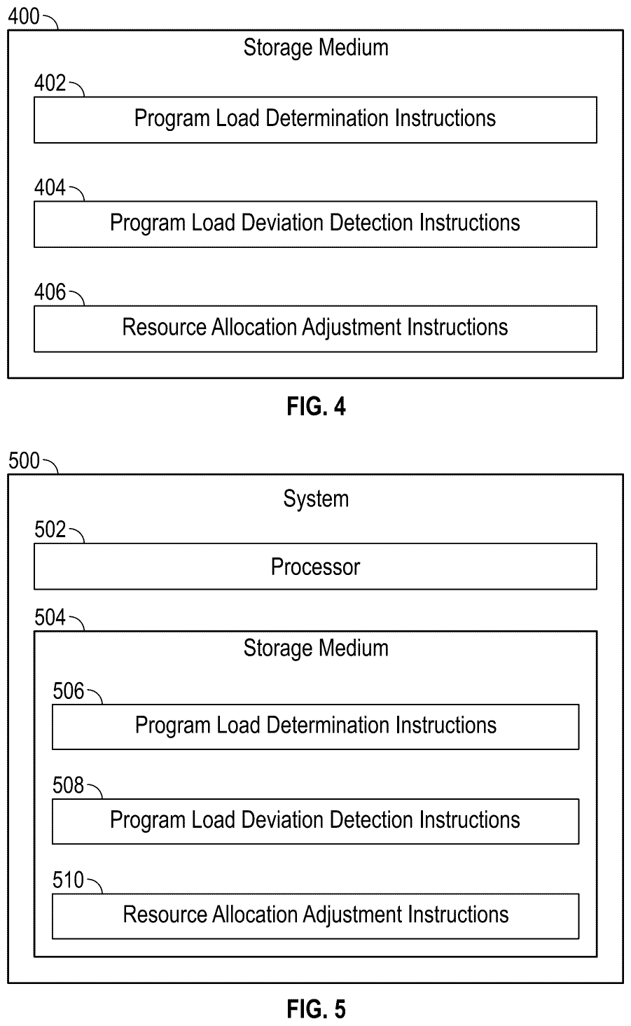

FIG. 4 is a block diagram of a non-transitory machine-readable or computer-readable storage medium 400 storing machine-readable instructions that upon execution cause a system to perform various tasks. An example of the system is the auto-scalar system 102 of FIG. 1.

The machine-readable instructions include program load determination instructions 402 to determine a program load of a program (e.g., 109 in FIG. 1) executing in a computing environment. The program load is determined based on a plurality of different usage parameters representing usage of different types of resources in the computing environment by the program, and based on respective resource allocation parameters representing allocations of the different types of resources. In an example, the program load is computed according to Eq. 2. The plurality of different usage parameters can include Current_Q_Size, Current_Instance_Quantity, and Current_Used_PR used in Eqs. 3-5, for example. The resource allocation parameters can include Allocated_Q_Size, Allocated_Instance_Quantity, and Allocated_PR used in Eqs. 3-5, for example.

The machine-readable instructions include program load deviation detection instructions 404 to detect that the determined program load deviates from a load threshold for the program. The deviation can include the determined program load exceeding the load threshold, or the determined program load not exceeding (e.g., being less than) the load threshold.

The machine-readable instructions include resource allocation adjustment instructions 406 to, based on detecting that the determined program load deviates from the load threshold, adjust a resource allocation parameter using an adjustment process that changes the resource allocation parameters in an order that depends upon whether the determined program load exceeds the load threshold or is less than the load threshold. The adjusting of the resource allocation parameter modifies an allocation of a resource of the different types of resources to the program.

In some examples, the order can be a first order if the determined program load exceeds the load threshold, and the order can be a second order different from the first order if the determined program load is less than the load threshold.

In some examples, the adjustment process includes changing a given resource allocation parameter of the resource allocation parameters according to the order, determining whether the change of the given resource allocation parameter would cause a modified program load of the program to satisfy the load threshold (e.g., the modified program load dropping or increasing to a target program load), and based on determining that the modified program load of the program would not satisfy the load threshold, further change another resource allocation parameter of the resource allocation parameters according to the order.

In some examples, the plurality of different usage parameters include parameters selected from among: a parameter representing usage of processing resources, a parameter representing usage of memory resources, a parameter representing usage of communication resources, a parameter representing usage of virtual resources, a parameter representing usage of program resources, or a parameter representing a quantity of instances of the program.

In some examples, the resource allocation parameters include parameters selected from among: an allocation parameter representing an allocation of the processing resources, an allocation parameter representing an allocation of the memory resources, an allocation parameter representing an allocation of the communication resources, an allocation parameter representing an allocation of the virtual resources, an allocation parameter representing an allocation of the program resources, or an allocation parameter representing an allocated quantity of instances of the program.

In some examples, a first usage parameter of the plurality of different usage parameters represents usage of memory resources by the program, and a first resource allocation parameter of the resource allocation parameters represents an allocation of the memory resources to the program.

In some examples, the usage of the memory resources by the program is based on a usage of a data queue for the program, and an adjustment of the first resource allocation parameter includes adjusting an allocated size of the data queue.

In some examples, a second usage parameter of the plurality of different usage parameters represents usage of processing resources by the program, and a second resource allocation parameter of the resource allocation parameters represents an allocated amount of the processing resources to the program.

In some examples, a third usage parameter of the plurality of different usage parameters represents a quantity of running instances of the program, and a third resource allocation parameter of the resource allocation parameters represents an allocated quantity of instances of the program.

In some examples, the adjustment process includes changing the resource allocation parameters according to a first order based on a determination that the determined program load exceeds the load threshold, and the changing of the resource allocation parameters according to the first order includes increasing the first resource allocation parameter before adjusting the second and third resource allocation parameters, determining whether the change of the first resource allocation parameter would cause a first modified program load of the program to satisfy the load threshold, based on determining that the first modified program load would not satisfy the load threshold, increasing the third resource allocation parameter, determining whether the change of the third resource allocation parameter (along with the change of the first resource allocation parameter) would cause a second modified program load of the program to satisfy the load threshold, and based on determining that the second modified program load would not satisfy the load threshold, increasing the second resource allocation parameter.

In some examples, the adjustment process includes changing the resource allocation parameters according to a second order different from the first order based on a determination that the determined program load is less than the load threshold, and the changing of the resource allocation parameters according to the second order includes decreasing the second resource allocation parameter before adjusting the first and third resource allocation parameters, determining whether the change of the second resource allocation parameter would cause a third modified program load of the program to satisfy the load threshold, based on determining that the third modified program load would not satisfy the load threshold, decreasing the third resource allocation parameter, determining whether the change of the third resource allocation parameter (along with the change of the second resource allocation parameter) would cause a fourth modified program load of the program to satisfy the load threshold, and based on determining that the fourth modified program load would not satisfy the load threshold, decreasing the first resource allocation parameter.

In some examples, the plurality of different usage parameters include three or more usage parameters, and the resource allocation parameters include three or more resource allocation parameters.

In some examples, increasing the resource allocation parameter reduces the program load of the program, and decreasing the resource allocation parameter increases the program load of the program.

FIG. 5 is a block diagram of a system 500 according to some examples. An example of the system 500 is the auto-scalar system 102 of FIG. 1. The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include program load determination instructions 506 to determine a program load of a program executing in a computing environment. The program load is determined based on at least three different usage parameters representing usage of different types of resources in the computing environment by the program, and based on respective resource allocation parameters representing allocations of the different types of resources.

The machine-readable instructions in the storage medium 504 include program load deviation detection instructions 508 to detect that the determined program load deviates from a load threshold for the program.

The machine-readable instructions in the storage medium 504 include resource allocation adjustment instructions 510 to, based on detecting that the determined program load deviates from the load threshold, adjust one or more of the resource allocation parameters using an adjustment process that changes the resource allocation parameters in a first order based on the determined program load exceeding the load threshold, and changes the resource allocation parameters in a second order different from the first order based on the determined program load being less than the load threshold. The adjusting of a resource allocation parameter modifies an allocation of a resource of the different types of resources to the program.

In some examples, the at least three different usage parameters include a first usage parameter, a second usage parameter, and a third usage parameter, and the resource allocation parameters include a first resource allocation parameter, a second resource allocation parameter, and a third resource allocation parameter. The program load is determined based on a relative value of the first usage parameter to the first resource allocation parameter (e.g., the first usage parameter divided by the first resource allocation parameter), a relative value of the second usage parameter to the second resource allocation parameter, and a relative value of the third usage parameter to the third resource allocation parameter.

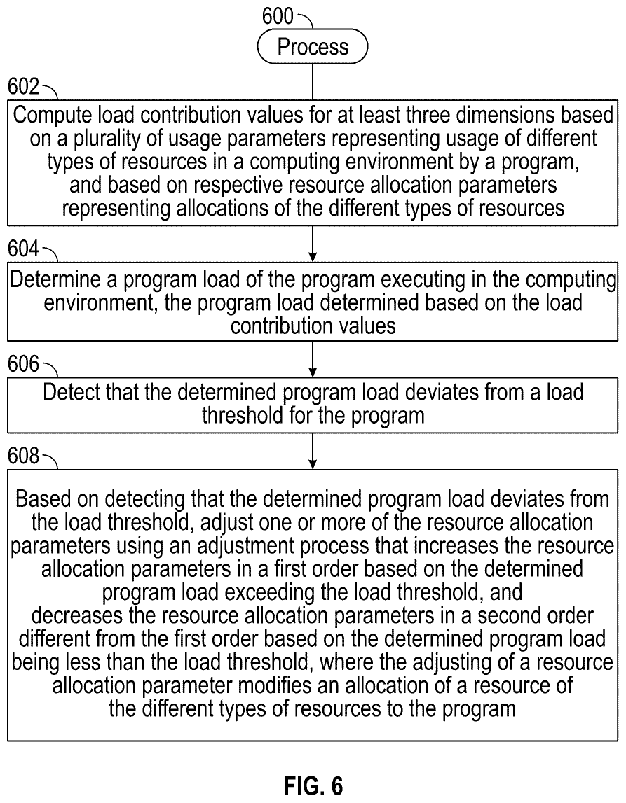

FIG. 6 is a flow diagram of a process 600 according to some examples. The process 600 can be performed by the auto-scalar system 102 of FIG. 1, for example.

Process 600 includes computing (at 602) load contribution values for at least three dimensions based on a plurality of usage parameters representing usage of different types of resources in the computing environment by the program, and based on respective resource allocation parameters representing allocations of the different types of resources. Examples of the load contribution values include the following: the X parameter representing the relative usage of the data queue as currently used by the program 109 (Eq. 3), the Y parameter representing the relative usage of the program instances 110 of the program 109 (Eq. 4), and the Z parameter representing the relative usage of the processing resources 104 by the program 109 (Eq. 5).

Process 600 includes determining (at 604) a program load of a program executing in a computing environment, the program load determined based on the load contribution values.

Process 600 includes detecting (at 606) that the determined program load deviates from a load threshold for the program. Based on detecting that the determined program load deviates from the load threshold, process 600 includes adjusting (at 608) one or more of the resource allocation parameters using an adjustment process that increases the resource allocation parameters in a first order based on the determined program load exceeding the load threshold, and decreases the resource allocation parameters in a second order different from the first order based on the determined program load being less than the load threshold, where the adjusting of a resource allocation parameter modifies an allocation of a resource of the different types of resources to the program.

A “processing resource” can include some combination of the following: a microprocessor, a core of a multi-core microprocessor, a microcontroller, a programmable integrated circuit, a programmable gate array, or another hardware processing circuit.

A “memory resource” can include any or some combination of the following: a collection of memory devices or a portion of the collection of memory device, a collection of storage devices or a portion of the collection of storage devices, or collections (or portions thereof) of other types of devices for storing data. As used here, a “collection” of items can refer to a single item or multiple items.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
determine a program load of a program executing in a computing environment, the program load determined based on a plurality of different usage parameters representing usage of different types of resources in the computing environment by the program, and based on respective resource allocation parameters representing allocations of the different types of resources;
detect that the determined program load deviates from a load threshold for the program; and
based on detecting that the determined program load deviates from the load threshold, adjust a resource allocation parameter using an adjustment process that changes the resource allocation parameters in an order that depends upon whether the determined program load exceeds the load threshold or is less than the load threshold, wherein the adjusting of the resource allocation parameter modifies an allocation of a resource of the different types of resources to the program.

2. The non-transitory machine-readable storage medium of claim 1, wherein the order in which the resource allocation parameters are changed in the adjustment process comprises:
a first order if the determined program load exceeds the load threshold, and
a second order different from the first order if the determined program load is less than the load threshold.

3. The non-transitory machine-readable storage medium of claim 1, wherein the adjustment process comprises:
changing a given resource allocation parameter of the resource allocation parameters according to the order,
determine whether the change of the given resource allocation parameter would cause a modified program load of the program to satisfy the load threshold, and
based on determining that the modified program load of the program would not satisfy the load threshold, further change another resource allocation parameter of the resource allocation parameters according to the order.

4. The non-transitory machine-readable storage medium of claim 1, wherein the plurality of different usage parameters comprise parameters selected from among: a parameter representing usage of processing resources, a parameter representing usage of memory resources, a parameter representing usage of communication resources, a parameter representing usage of virtual resources, a parameter representing usage of program resources, or a parameter representing a quantity of instances of the program.

5. The non-transitory machine-readable storage medium of claim 4, wherein the resource allocation parameters comprise parameters selected from among: an allocation parameter representing an allocation of the processing resources, an allocation parameter representing an allocation of the memory resources, an allocation parameter representing an allocation of the communication resources, an allocation parameter representing an allocation of the virtual resources, an allocation parameter representing an allocation of the program resources, or an allocation parameter representing an allocated quantity of instances of the program.

6. The non-transitory machine-readable storage medium of claim 1, wherein a first usage parameter of the plurality of different usage parameters represents usage of memory resources by the program, and a first resource allocation parameter of the resource allocation parameters represents an allocation of the memory resources to the program.

7. The non-transitory machine-readable storage medium of claim 6, wherein the usage of the memory resources by the program is based on a usage of a data queue for the program, and wherein an adjustment of the first resource allocation parameter comprises adjusting an allocated size of the data queue.

8. The non-transitory machine-readable storage medium of claim 6, wherein a second usage parameter of the plurality of different usage parameters represents usage of processing resources by the program, and a second resource allocation parameter of the resource allocation parameters represents an allocated amount of the processing resources to the program.

9. The non-transitory machine-readable storage medium of claim 8, wherein a third usage parameter of the plurality of different usage parameters represents a quantity of running instances of the program, and a third resource allocation parameter of the resource allocation parameters represents an allocated quantity of instances of the program.

10. The non-transitory machine-readable storage medium of claim 9, wherein the adjustment process comprises changing the resource allocation parameters according to a first order based on a determination that the determined program load exceeds the load threshold, and wherein the changing of the resource allocation parameters according to the first order comprises:
increasing the first resource allocation parameter before adjusting the second and third resource allocation parameters,
determining whether the change of the first resource allocation parameter would cause a first modified program load of the program to satisfy the load threshold,
based on determining that the first modified program load would not satisfy the load threshold, increasing the third resource allocation parameter,
determining whether the change of the third resource allocation parameter would cause a second modified program load of the program to satisfy the load threshold, and
based on determining that the second modified program load would not satisfy the load threshold, increasing the second resource allocation parameter.

11. The non-transitory machine-readable storage medium of claim 10, wherein the adjustment process comprises changing the resource allocation parameters according to a second order different from the first order based on a determination that the determined program load is less than the load threshold, and wherein the changing of the resource allocation parameters according to the second order comprises:
decreasing the second resource allocation parameter before adjusting the first and third resource allocation parameters,
determining whether the change of the second resource allocation parameter would cause a third modified program load of the program to satisfy the load threshold,
based on determining that the third modified program load would not satisfy the load threshold, decreasing the third resource allocation parameter,
determining whether the change of the third resource allocation parameter would cause a fourth modified program load of the program to satisfy the load threshold, and
based on determining that the fourth modified program load would not satisfy the load threshold, decreasing the first resource allocation parameter.

12. The non-transitory machine-readable storage medium of claim 1, wherein the plurality of different usage parameters comprise three or more usage parameters, and the resource allocation parameters comprise three or more resource allocation parameters.

13. The non-transitory machine-readable storage medium of claim 1, wherein increasing the resource allocation parameter reduces the program load of the program, and decreasing the resource allocation parameter increases the program load of the program.

14. A system comprising:
a processor; and
a non-transitory machine-readable storage medium storing instructions executable on the processor to:
determine a program load of a program executing in a computing environment, the program load determined based on at least three different usage parameters representing usage of different types of resources in the computing environment by the program, and based on respective resource allocation parameters representing allocations of the different types of resources;
detect that the determined program load deviates from a load threshold for the program; and
based on detecting that the determined program load deviates from the load threshold, adjust one or more of the resource allocation parameters using an adjustment process that changes the resource allocation parameters in a first order based on the determined program load exceeding the load threshold, and changes the resource allocation parameters in a second order different from the first order based on the determined program load being less than the load threshold, wherein the adjusting of a resource allocation parameter modifies an allocation of a resource of the different types of resources to the program.

15. The system of claim 14, wherein the at least three different usage parameters comprise a first usage parameter, a second usage parameter, and a third usage parameter, and the resource allocation parameters comprise a first resource allocation parameter, a second resource allocation parameter, and a third resource allocation parameter, and
wherein the program load is determined based on a relative value of the first usage parameter to the first resource allocation parameter, a relative value of the second usage parameter to the second resource allocation parameter, and a relative value of the third usage parameter to the third resource allocation parameter.

16. The system of claim 15, wherein the changing of the resource allocation parameters in the first order comprises:
changing the first resource allocation parameter before adjusting the second and third resource allocation parameters;
determining whether the change of the first resource allocation parameter would cause a first modified program load of the program to satisfy the load threshold;
based on determining that the first modified program load would not satisfy the load threshold, changing the second resource allocation parameter;
determining whether the change of the second resource allocation parameter would cause a second modified program load of the program to satisfy the load threshold, and
based on determining that the second modified program load would not satisfy the load threshold, changing the third resource allocation parameter.

17. The system of claim 16, wherein the changing of the resource allocation parameters in the second order comprises:
changing the third resource allocation parameter before adjusting the first and second resource allocation parameters;
determining whether the change of the third resource allocation parameter would cause a third modified program load of the program to satisfy the load threshold;
based on determining that the third modified program load would not satisfy the load threshold, changing the second resource allocation parameter;
determining whether the change of the second resource allocation parameter would cause a fourth modified program load of the program to satisfy the load threshold, and
based on determining that the second modified program load would not satisfy the load threshold, changing the first resource allocation parameter.

18. The system of claim 14, wherein the at least three different usage parameters comprise a first usage parameter representing usage of memory resources, a second usage parameter representing a quantity of running instances of the program, and a third usage parameter representing usage of processing resources.

19. A method comprising:
computing, by a system comprising a hardware processor, load contribution values for at least three dimensions based on a plurality of usage parameters representing usage of different types of resources in a computing environment by a program, and based on respective resource allocation parameters representing allocations of the different types of resources;
determining, by the system, a program load of the program executing in the computing environment, the program load determined based on the load contribution values;
detecting, by the system, that the determined program load deviates from a load threshold for the program; and
based on detecting that the determined program load deviates from the load threshold, adjusting, by the system, one or more of the resource allocation parameters using an adjustment process that increases the resource allocation parameters in a first order based on the determined program load exceeding the load threshold, and decreases the resource allocation parameters in a second order different from the first order based on the determined program load being less than the load threshold, wherein the adjusting of a resource allocation parameter modifies an allocation of a resource of the different types of resources to the program.

20. The method of claim 19, wherein the computing of the load contribution values comprises:
computing a first load contribution value representing a contribution to the program load due to usage of memory resources,, the first load contribution value computed based on a ratio of a usage parameter representing usage of the memory resources by the program to a resource allocation parameter representing an allocation of the memory resources to the program,
computing a second load contribution value representing a contribution to the program load due to a current quantity of instances of the program that are running, the second load contribution value computed based on a ratio of a usage parameter representing the current quantity of instances of the program that are running to a resource allocation parameter representing an allocated quantity of instances of the program, and
computing a third load contribution value representing a contribution to the program load due to usage of processing resources,, the third load contribution value computed based on a ratio of a usage parameter representing usage of the processing resources by the program to a resource allocation parameter representing an allocation of the processing resources to the program.
